(19) United States
(12) Patent Application Publication
(10) Pub. No.: US 2005/0097536 A1
(43) Pub. Date: May 5, 2005

(54) Method of graphically displaying and manipulating multiple workflow run instances of a software application

(76) Inventors: David R. Bernstein, Scotts Valley, CA (US); Rodrigo A. Laguisma, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/940,387

(22) Filed: Sep. 13, 2004

Related U.S. Application Data
(60) Provisional application No. 60/502,019, filed on Sep. 11, 2003.
(60) Provisional application No. 60/502,018, filed on Sep. 11, 2003.

(51) Int. Cl. G06F 9/45

(52) U.S. Cl. 717/156; 717/155; 717/157

(57) ABSTRACT

Methods for graphically displaying multiple task workflow run instances associated with execution of a software application is disclosed. The software application can be associated with, in one embodiment, a network analyzer for monitoring data transmissions in a communications network. A graphical user interface is employed to graphically depict a plurality of workflow run instances representing tasks executed by the software application. The workflow run instances are temporally arranged in a stacked configuration according to a Gantt chart design. A selector including a vertical selector bar and a selector block is movable over the workflow run instances to select one or more specified workflow run instance portions at a given time point. Once selected, data and other details relating to the selected workflow run instance portions are displayed.

### CROSS-REFERENCE TO RELATED APPLICATIONS

This application claims the benefit of the following U.S. Provisional Patent Applications: Application No. 60/502,019, filed on Sep. 11, 2003, entitled “GANTT CHART GUI METAPHOR FOR OUTPUT OF MULTI-WORKFLOW RUN INSTANCES;” and Application No. 60/502,018, filed on Sep. 11, 2003, entitled “RUNTIME BINDING OF APPLICATION TO NETWORK.” Each of the aforementioned applications is incorporated herein by reference in its entirety.

### BACKGROUND

1. Technology Field

The present invention generally relates to software applications. In particular, the present invention relates to graphically depicting multiple workflow run instances performed by a software application in conjunction with a communications network via a graphical user interface.

2. The Related Technology

Modern computer networks involve the transmission of large amounts of data at very high speeds across the networks. For example, in some networks, transmission rates as high as 10 Gbits/second are currently being used. Today, hardware and protocols that will support transmission rates up to 40 Gbits/second are being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period.

One example of a network analysis tool mentioned above is known as a network analyzer. Network analyzers utilize a combination of hardware and software components to monitor data transmitted across the network, to capture such data upon the execution of one or more triggers, and to analyze captured data in order to diagnose or detect problem conditions existing on the network. As such, the software applications that cooperate with hardware components of the network analyzer are critical to ensure proper data traffic monitoring, capture and problem condition diagnosis. Indeed, software applications used in this manner can be employed to view and/or manipulate various network configurations and overall topology of the physical network. Thus, these software applications are highly beneficial in maximizing the utility of network analyzers and other types of network analysis tools.

Many known network analyzers and similar apparatus utilize both hardware and software components in order to perform monitoring and diagnostic functions within the communications network. Often, network analyzers are configured such that they perform multiple tasks during operation, with many of these tasks performed simultaneously.

Each task performed by the software of a network analyzer may be composed of a single procedure, or work item, or a sequence of work items to be executed. One specification for the sequencing of these work items is called a “workflow”. The workflow specification is visualized as a directed graph, more formally known as a Petri Net. The Petri Net contains constructs that represent the procedures to be executed and their related paths and possible branches that are followed during task execution based on data conditions, timing, and other factors that occur in the work items themselves or that are evaluated in decision or calculation nodes of the Petri Net. Thus, a Petri Net construction illustrates the various workflow specifications of a particular task to be executed by the software of a network analyzer, including procedure iteration, branching, joining, event generation, event activation, and many other commonly known directed graph constructs.

Traditional screen displays associated with software applications often fail to adequately depict details regarding one or more workflows executed by the application. This failure is particularly evident when such workflows are performed simultaneously with respect to one another. However, in the realm of network analysis tools, the ability for a user to readily view the details of one or more specified workflows and to maneuver between the multiple workflow run instances being executed by a network analyzer is essential for rapid analysis of network conditions.

In light of the above, a need therefore exists for a method by which identification and data relating to multiple workflow run instance run instances executed by a software application can be graphically depicted by a computer system having a display device, so as to enable the progress or status of each workflow run instance run instance to be easily ascertained by a user. In addition, it would be an advancement in the art to enable the selective display of details regarding selected workflow run instance run instances performed by a software application. Additionally, any advancement that can be adapted for use with network analysis tools, such as hardware and software-based network analyzers, to monitor and diagnose problem conditions in a communications network is also desired.

### BRIEF SUMMARY

Briefly summarized, embodiments of the present invention are directed to a method by which data and other details regarding tasks performed by a software application can be graphically depicted via a graphical user interface. Embodiments of the present invention can be practiced on a computer system having a screen display, for example, wherein the computer system interacts with a communications network. In one embodiment, the computer system is a network analyzer that monitors data transmission activities within a communications network. Therefore, the workflow tasks performed or executed by a software application that is associated with the computer system are utilized in such monitoring of the communications network.

Embodiments of the present invention enable tasks that are executed by a software application to be displayed as one or more workflow run instances using a Gantt chart configuration. The Gantt chart depiction of workflow run instances representing various past or current tasks performed by the software application can be displayed in a visual format via a graphical user interface, thereby enabling a user to selectively identify any one or more of the workflow run instances performed by the software application. The Gantt chart format provides an easy to understand time-based display that is easily navigable by the user.

Employing a selector that is included in the graphical user interface, the user can select the desired workflow run instance. Data and other details regarding the workflow run instance are then immediately produced on the display, thereby enabling the user to view such details. In the case of two or more workflow run instances being simultaneously selected, details or data regarding each of the selected workflow run instances can be simultaneously displayed. This enables a user to readily identify the progress or details of the multiple workflow run instances relating to the software application, thereby further enabling performance of the software application to be maximized. When used in conjunction with a network analyzer for monitoring data transmissions within a communications network, depiction of the various workflow run instances of the software application enable a user to more readily identify problem conditions present in the communications network.

In one embodiment, then, a method is disclosed of selectively displaying data relating to multiple workflow run instances executed by a software application. The method includes displaying a plurality of workflow run instances arranged in a time-based format via a graphical user interface, enabling the selection of at least one workflow run instance via a selector block of the graphical user interface, and depicting data relating to the selected workflow run instance.

In another embodiment, a computer program product for implementing a method of displaying data relating to multiple workflow run instances executed by a software application is disclosed, and includes a computer readable medium carrying computer executable instructions for performing a method that includes displaying a plurality of workflow run instances arranged in a Gantt chart format, enabling the selection of at least one workflow run instance via a selector block of a graphical user interface, and depicting data relating to the selected workflow run instance.

In yet another embodiment, a method of selectively displaying data relating to multiple workflow run instances executed by a software application is disclosed and comprises displaying a plurality of workflow run instances arranged in a Gantt chart format via a graphical user interface, enabling the selection of at least one workflow run instance via at least two selector blocks of the graphical user interface; and depicting data relating to the selected at least one workflow run instance.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram showing various details of one environment in which embodiments of the present invention can be practiced;

FIG. 2A is a simplified depiction of a directed graph illustrating various procedures comprising a computer executable task;

FIG. 2B is a workflow run instance representation of the directed graph shown in FIG. 2A;

FIG. 3A is a screen display showing various elements of a workflow run instance diagram graphical user interface having a Gantt chart format, according to one embodiment;

FIG. 3B is a screen display showing data relating to selected workflow run instances illustrated in FIG. 3A;

FIG. 4A is a screen display showing a Gantt chart format graphical user interface having a selector configured in accordance with another embodiment;

FIG. 4B is a screen display showing a Gantt chart format graphical user interface having multiple selectors configured in accordance with yet another embodiment; and

FIG. 5 is a block diagram showing various stages of a method according to one embodiment of the present invention.

### DETAILED DESCRIPTION OF SELECTED EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

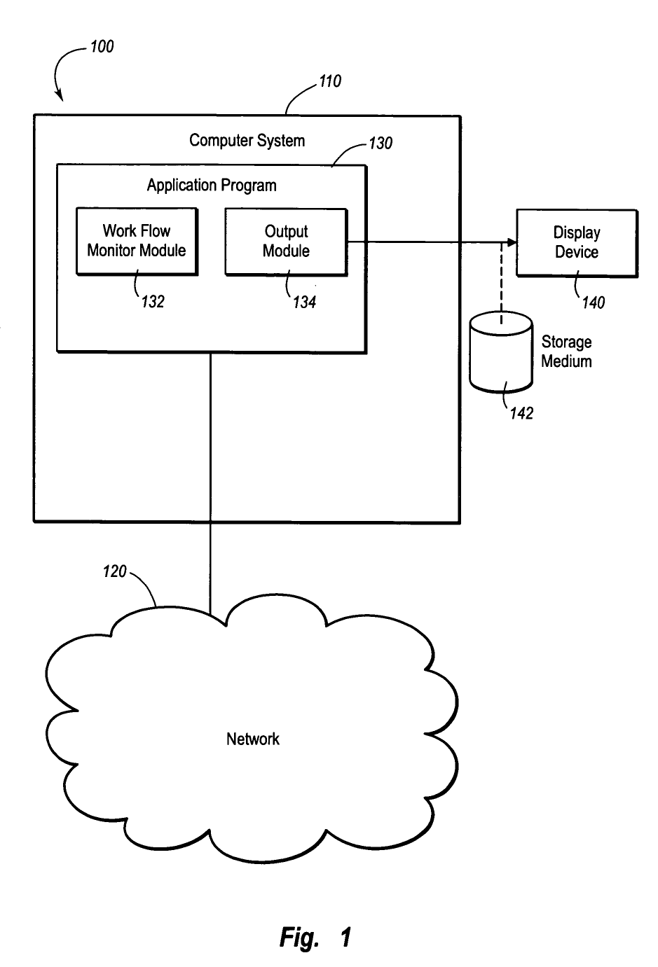

FIGS. 1-5 depict various features of embodiments of the present invention, which is generally directed to a method by which various executed or executing tasks associated with a software application, represented herein as workflow run instances, can be visually depicted in a Gantt chart format via a graphical user interface. The depiction of workflow run instances in this manner enables a user to readily ascertain the status of multiple workflow run instances associated with the software application, while also enabling immediate access to workflow run instance-related data or other details associated therewith.

Reference is first made to FIG. 1, which depicts an exemplary operating environment, generally depicted at 100, in which embodiments of the present invention can be practiced. In detail, the environment 100 includes a computer system 110 that is in communication with a communications network 120. The communications network 120 can include, but is not limited to, Local Area Networks, Wide Area Networks, the Internet and the like or any other combination thereof. The communications network 120 can be either a wired and/or wireless network.

In one embodiment, the computer system 110 is a network analyzer or similar apparatus for monitoring network data traffic in the communications network 120 in order to detect and diagnose problem conditions existing in the network, such as problem conditions existing between network components (not shown here), or links between components.

The computer system 110 includes an application program 130 including computer executable instructions that are included in one or more modules. For instance, in one embodiment, the application program 130 includes a workflow monitor module 132 and an output module 134. As configured here, the workflow monitor module 132 monitors procedures and tasks associated with the monitoring of the communications network 120 by the computer system 110 in conjunction with the application program 130. Results obtained by the workflow monitor module 132, referred to here as “workflow run instances” and explained in greater detail further below, can be compiled and output via the output module 134. In the illustrated embodiment, data that is received and/or compiled by the output module 134 is directed in one embodiment to a display device 140 for visual presentation to a user (not shown) in a manner to be described further below. Alternatively, the data that is output via the output module 134 can be temporarily stored in a storage medium 142 before or after being forwarded to the display device 140.

In addition to the workflow monitor module 132 and output module 134, other modules containing computer executable instructions can be contained within the application program 130. Indeed, the modules shown in FIG. 1 are exemplary, and it is appreciated that additional or other modules can alternatively be included in the application program 130 to accomplish similar tasks to those described herein. Also, though described herein as a network analyzer, the computer system 110 can include any one of the variety of computer systems, including specific or general purpose computers designed according to a particular need. In addition, embodiments of the present invention can be employed in connection with networks of various types, configurations, and purposes. Thus, the description of the various embodiments described as contained herein should not be construed as limiting the present invention in any way.

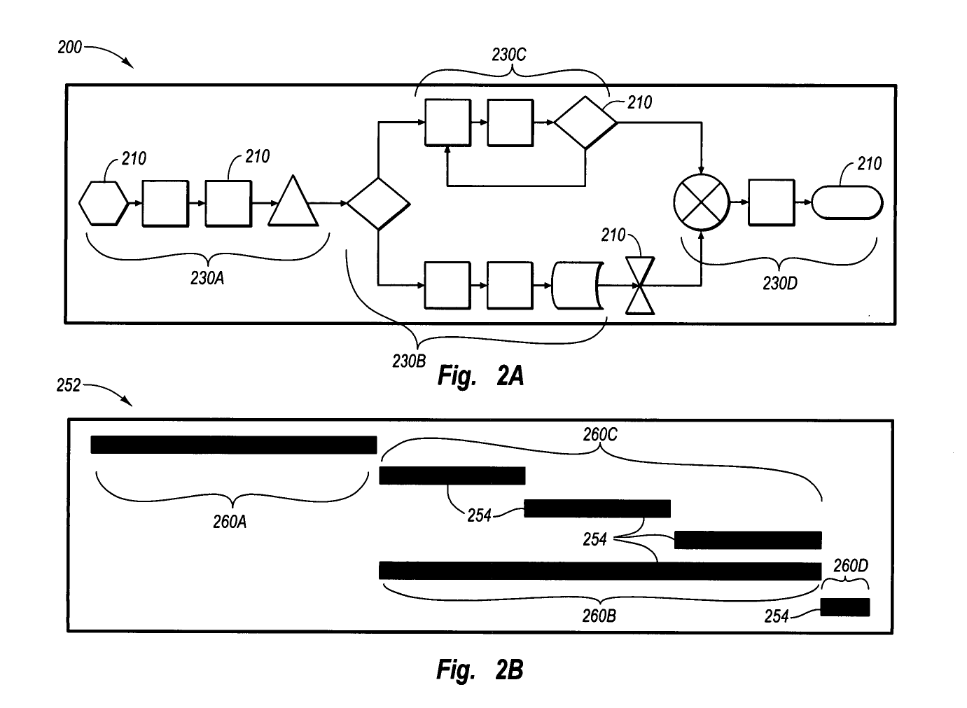

Reference is now made to FIG. 2A. In one embodiment, the application program 130 of FIG. 1 includes various modules that are designed to provide computer executable instructions for the computer system 110 to execute. These computer executable instructions are arranged into tasks each containing a plurality of procedures for executing the task. FIG. 2A depicts such a task arranged in what is known as a directed graph, generally depicted at 200. The directed graph 200 includes graphic depictions of various operations 210, which are differentiated in shape according to their purpose, as is known in the art.

As can be seen, the flow of operations 210 can proceed along one or more paths defined by the directed graph 200. For example, segment 230A of the directed graph 200 contains operations 210 that are executed first. The directed graph 200 then diverges, and flow of the task can travel along either divergent path, according to task input, parameters, etc. In one case, task flow proceeds along segment 230B, wherein corresponding operations 210 are executed. In another case, task flow proceeds along segment 230C, where one or more iterations of the corresponding operations 210 are executed. Regardless of which of the segments 230B or 230C is followed, segment 230D is then executed via its corresponding operations 210 to complete the task. Generally, for a task represented by a directed graph, one or more iterations of selected operations can occur according to the flow of the task during application execution, while other operations are not executed at all. In yet other situations, some operations are executed simultaneously with other operations. Thus, the depiction of a directed graph in FIG. 2A is merely exemplary of the variety of operation configurations that are possible in charting the flow of a task.

Reference is now made now to FIG. 2B, which depicts another representation of the task depicted by the directed graph 200 in FIG. 2A. In detail, FIG. 2B depicts the task in terms of a workflow run instance, generally depicted at 252. As mentioned above, When a task is actually executed or performed by a software application, the directed graph is traversed and results in a workflow run instance, such as that depicted at 252 in FIG. 2B. Thus, it is seen that the visualization of the workflow run instance 252 is not topologically equivalent to the directed graph 200 of FIG. 2A in that the directed graph is a programmatic specification of all possible traversals, or operation execution flow paths, of task. In contrast, the workflow run instance 252 depicts an actual flow of the task as executed by the various operations contained therein.

As seen in FIG. 2B, the workflow run instance 252 depicts the task in a temporal format in that the task progresses from left to right across the page. Various bars are also shown in FIG. 2B that represent workflow run instance portions 254, which together form the workflow run instance 252. Each workflow run instance portion 254 represents certain of the operations 210 that form the task shown in the directed graph 200 of FIG. 2A. Further, the workflow run instance portions 254 that are arranged such that their beginning and end points are vertically aligned execute simultaneously with one another.

In greater detail, the workflow run instance portions 254 of the workflow run instance 252 shown in FIG. 2B each correspond to one of the segments 230A-D of the directed graph 200 of FIG. 2A. For instance, segment 230A of directed graph 200 corresponds to the workflow run instance portion 254 encompassed by the segment 260A, and segment 230D corresponds to the workflow run instance portion encompassed by the segment 260D. In addition, the segment 230C of the directed graph 200 corresponds to the workflow run instance portions 254 encompassed by the segment 260C. In the present embodiment, the operations 210 that compose the directed graph segment 230C are iteratively executed three times. Thus, the segment 260C of the workflow run instance 252 depicts three workflow run instance portions 254 temporally occurring one after another, each portion representing one of the iterations of the segment loop 230C. Note the endpoint of one workflow run instance portion 254 is aligned with the beginning point of the proceeding portion, indicating iteration of the execution loop immediately following the termination of the previous execution loop. Similarly, the segment 230B of the directed graph 200 corresponds to the workflow run instance portion 260B of FIG. 2B, and runs concurrently with the iterative segment 260C described above.

As shown in FIG. 2B, then, the task represented by the workflow run instance 252 graphically commences at the upper left portion of the figure with segment 260A and proceeds, either singularly or simultaneously, through the various workflow run instance portions 254 until terminating at the final workflow run instance portion at segment 260D and illustrated at the bottom right portion of the figure. The representation of the task as shown by the workflow run instance 252 in FIG. 2B is typical of a graphical method of displaying multiple-operation tasks called a Gantt chart. Workflow run instances depicted in a Gantt chart format offer a convenient manner by which a computer executable task can be displayed and followed during execution of the application program.

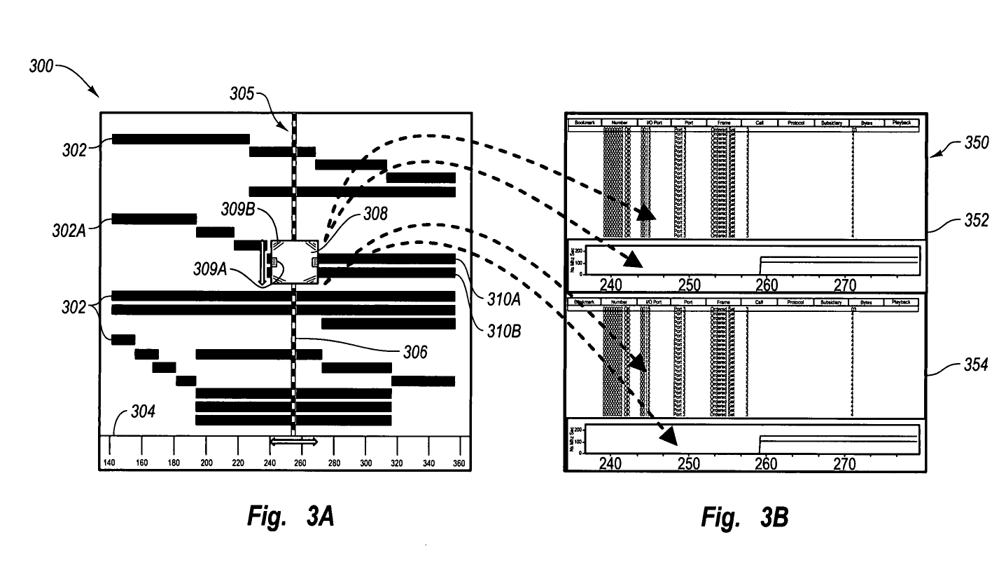

Reference is now made to FIGS. 3A and 3B, which depict screen displays that are configured in accordance with one embodiment of the present invention. The screen displays shown in these figures can be depicted on a display device, such as the display device 140 of FIG. 1, or other suitable apparatus. In detail, FIG. 3A depicts a graphical user interface (“GUI”), generally designated at 300. The GUI 300 is configured in one embodiment to enable a user (not shown) to navigate between a plurality of work flows 302 that are configured in accordance with a Gantt chart format, similar to the workflow run instance 252 shown in FIG. 2B. The workflow run instances 302 represent various tasks executed by the application program 130 (FIG. 1). The workflow run instances 302 can include tasks already executed and/or tasks that are currently being executed by the application program 130. The tasks 302 are temporally arranged in a left-to-right chronological fashion in the GUI 300 as shown in FIG. 3A. As such, a timeline 304 is included in the GUI 300 in order to provide a temporal reference point for the various workflows 302. As before, the workflow run instances 302 include a plurality of workflow run instance portions, as previously shown in FIG. 2B. If desired, each workflow run instance 302 or run instance portion can be displayed in a different color in order to distinguish between the various workflow run instances.

The workflow run instances 302 are shown in a vertically stacked configuration, in accordance with the fact that multiple, simultaneous tasks can be executed by the application program at any given point in time, again in accordance with Gantt chart format conventions.

It is often desirable for data and other details regarding the execution of the tasks represented by the workflow run instances 302 to be viewed by a user. To that end, embodiments of the present invention provide a manner by which such data can be viewed. In particular, a selector 305 is included in the GUI 300 to enable data regarding selected workflow run instances to be viewed. In detail, the selector 305 according to one embodiment includes a vertical selector bar 306 together with a selector block 308. The vertical selector bar 306 is horizontally moveable along the longitudinal lengths of the various work flows 302 as indicated by the arrow in FIG. 3A, and assists in determining the temporal position of the selector block 308 with respect to the timeline 304. According to GUI conventions, click and drag operations on a portion of the vertical selector bar 306 via user input, such as a mouse (not shown), can be used to selectively position the bar along the timeline 304. In one embodiment, a “snap to grid” feature can be included to accurately position the vertical selector bar 306.

In contrast, the selector block 308 is vertically moveable along the length of the vertical selector bar 306 as indicated by the respective arrow in FIG. 3A, thereby enabling specified portions of one or more of the workflow run instances 302 to be selected thereby. In particular, click and drag operations on a portion of the selector block 308 via user input can be used to selectively position the selector block horizontally or vertically to any region of the working space of the GUI 300, according to GUI conventions. In this way, a portion of any of the workflow run instances 302 can be accessed by the selector 305, thereby enabling a workflow run instance at any location in the GUI and at any point along the timeline 304 to be accessed.

In the illustrated embodiment, the selector block 308 includes edge indicators 309A and corner indicators 309B. Via a click and drag operation or other suitable user input, the edge indicators 309A can be used to laterally expand or decrease the width of the selector block 308, while the corner indicators 309B can be used to expand or decrease the overall size of the selector block. A “snap to grid” feature in one embodiment can enable the selector block 308 to be sized to discrete increments. This snap to grid feature can enable both the vertical selector bar 306 and the selector block 308 to be accurately positioned with respect to the timeline 304 and the various workflow run instances 302. In one embodiment, clicking on a portion of the selector block 308, such as via a mouse, then using keyboard strokes, such as arrow keys, can also be used to alter the size of the selector block. Upon manipulation of the size of the selector block 308 in this manner, the vertical selector bar 306 can be configured to snap to the new center point of the selector block.

As shown in FIG. 3A, the selector 305 is exemplarily positioned such that the selector block 308 overlies a portion of a selected workflow run instance 302A. In particular, the selector block 308 overlies workflow run instance portions 310A and 310B of the selected workflow run instance 302A. The horizontal position of the vertical selector bar 306 is centered at time 260 of the timeline 304, such that details regarding execution of the task as represented by the selected workflow run instance 302A can be ascertained with respect to the workflow run instance portions 310A and 310B at time 260 of the task execution.

Once the workflow run instance 302A is selected by cooperative movement of the vertical selector bar 306 and selector block 308 of the selector 305, the GUI 300 can enable data regarding the task represented by the workflow run instance to be selectively viewed, either automatically or according to user input via a mouse click, keyboard action, etc. FIG. 3B shows such a display of data, wherein a display element 350 is depicted displaying data regarding the workflow run instance portions 310A and 310B at a particular time point range as seen by the selector configuration of FIG. 3A. In detail, FIG. 3B shows data output 352 corresponding to the workflow run instance portion 310A, and data output 354 corresponding to the workflow run instance portion 310B from time point 240 to time point 270, which corresponds to the horizontal span of the selector block 308 across the timeline 304 in FIG. 3A.

The display element 350 can include various sets of information that relate to the task that is executed by the application program and represented by the selected workflow run instance. Configured in one embodiment by the output module 134 of the application program 130 (FIG. 1), the data and contents of the display element 350 can be automatically chosen by the output module based on a matching algorithm resolving the inherent data type of the workflow run instance, the available output module display element capabilities (“controls”), and user configurable preferences information. Configuration of this matching algorithm would be embodied in “property sheets” and “options” of the Output Module 134.

The display element 350 can be updated by movement of the selector 305 in the GUI 300 (FIG.3A). For instance, should information regarding workflow run instance portions 310A and 310B at another point in time be desired, the vertical selector bar 306 can be horizontally maneuvered in either direction within the GUI 300 without altering the vertical placement of the selector block 308.

As mentioned, in one embodiment movement of the vertical selector bar 306 and selector block 308 is achieved by placing a mouse over the selector bar or selector block and initiating a mouse “click and drag” operation. This or other suitable action will move the selector 305 as desired in order to position the vertical selector bar 306 and/or selector block 308 over a desired workflow run instance portion of a workflow run instance 302.

In one embodiment, the GUI 300 is separately displayed with respect to the 350. In other words, once a workflow run instance is selected by the selector 305 in GUI 300, the screen is refreshed to show the data as reflected in the display element 350. In another embodiment, both the GUI 300 and the display element 350 coexist on a single screen display.

It is also appreciated that one, two, or more workflow run instance portions can be represented by the display element 350 at a given time, according to the position of the selector block 308, and that the relative positions of the various workflow run instances 302 can be vertically interchanged within the GUI 300, if desired. Further, note that, while the workflow run instances 302 of the GUI 300 in FIG. 3A extend temporally from left to right, it is possible that in other embodiments the workflow run instances extend in other directions in the GUI. In such a case, the selector is modified in order to suitably navigate the workflow run instances. Thus, the GUI of FIG. 3A and its associated elements should not be construed as limiting the present invention in any way.

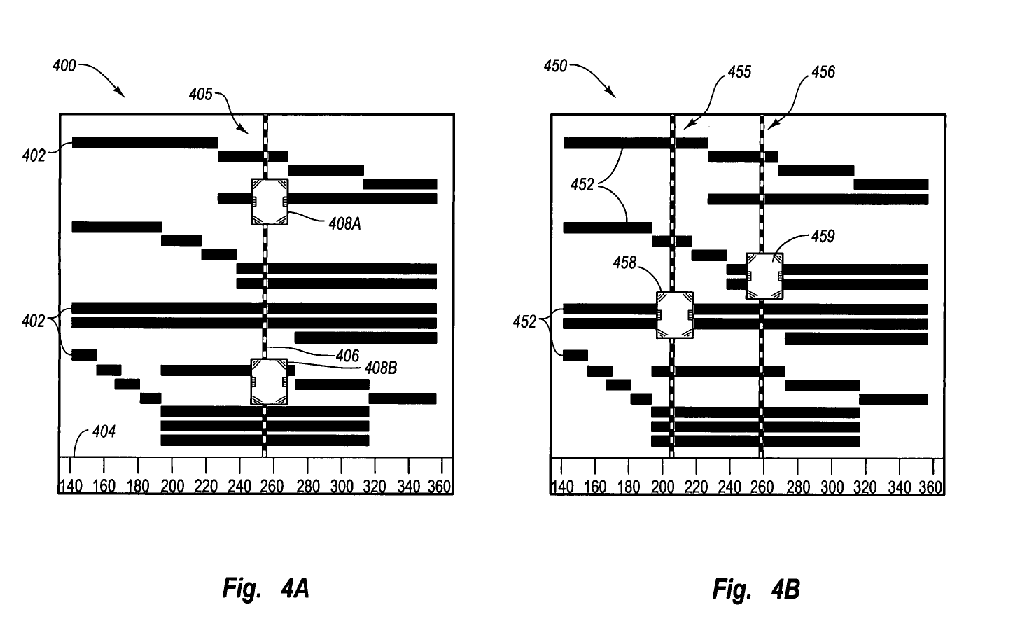

Reference is now made to FIGS. 4A and 4B. As mentioned, the GUI and its elements can be modified from that which is shown in FIG. 3A to meet the needs of a particular application. The embodiments shown in FIGS. 4A and 4B are examples of such modifications. In detail, FIG. 4A shows a GUI, generally designated at 400, displaying a plurality of workflow run instances 402 that are arranged in a Gantt chart format, as before. A timeline 404 is depicted, and a selector 405 having a vertical selector bar 406 is also included in the GUI 400. In contrast to the previous embodiment, however, the selector 405 includes two selector blocks 408A and 408B that are independently controllable with respect to one another. This enables workflow run instances that are not adjacent one another to be accessed by the selector 405, thereby expanding the capability thereof.

FIG. 4B depicts a GUI, generally designated at 450, that includes a plurality of workflow run instances 452 and two discrete selectors 455 and 456. The selector 455 includes a selector block 458, and the selector 456 includes selector block 459, such that each selector is independently operable within the GUI 450 to ascertain details and other data regarding the workflow run instances 452 contained therein. This offers expanded capability for the user in viewing GUI data in the manner described above.

More generally, it is appreciated that the size of the selector block(s) of the selector can be modified from that shown in the accompanying figures in order to be able to capture relatively more workflow run instances at one time. Indeed, the size of the workflow run instances and selector block(s) can be modified relative one another in order to fit an increased number of workflow run instances in the GUI depiction, if necessary.

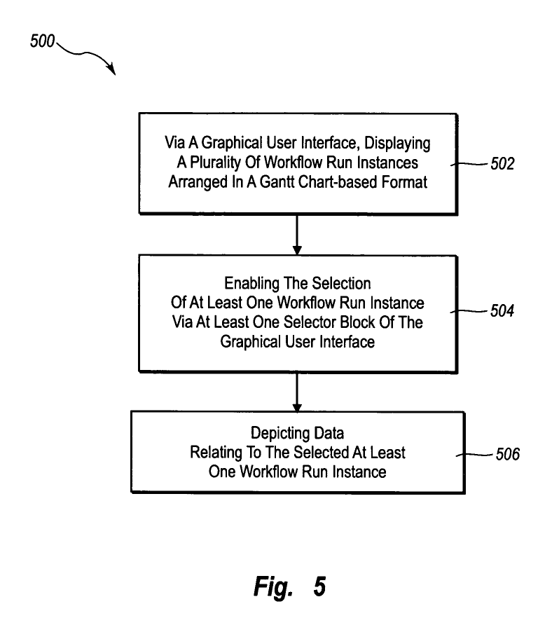

Reference is now made to FIG. 5, which includes various aspects regarding a method, generally depicted at 500, of selectively displaying data relating to multiple workflow run instances executed by a software application. In stage 502, a plurality of workflow run instances arranged in a time-based format is displayed via a graphical user interface. The time-based format in one embodiment is a Gantt chart format, as described above. Stage 504 includes enabling the selection of at least one workflow run instance via at least one selector block of the graphical user interface. In stage 506, data relating to the selected workflow run instance is depicted.

Principles of embodiments of the present invention can be practiced in connection with features of a U.S. Patent Application entitled “METHOD OF CREATING A VIRTUAL NETWORK TOPOLOGY FOR USE IN A GRAPHICAL USER INTERFACE,” having inventors David R. Bernstein and Rodrigo Laguisma, filed concurrently herewith, which is incorporated herein by reference in its entirety.

With respect to computing environments, communications networks, and related components in general, at least some embodiments of the present invention may be implemented in connection with a special purpose or general purpose computer that is adapted for use in connection with communications systems. Embodiments within the scope of the present invention also include computer-readable media for carrying or having computer-executable instructions or electronic content structures stored thereon, and these terms are defined to extend to any such media or instructions for use with devices such as, but not limited to, link analyzers and multi-link protocol analyzers.

By way of example, such computer-readable media can include RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such connection is properly termed a computer-readable medium. Combinations of the above should also be included within the scope of computer-readable media. Computer-executable instructions comprise, for example, instructions and content which cause a general purpose computer, special purpose computer, special purpose processing device, such as link analyzers and multi-link protocol analyzers, or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

A computer system as described herein can include a processing unit, a system memory, and a system bus that couples various system components including the system memory to the processing unit. The computer system is connectable to networks, such as, for example, an office-wide or enterprise-wide computer network, an intranet, and/or the Internet. The computer system can exchange data with external sources, such as, for example, remote computer systems, remote applications, and/or remote databases over such a network.

The computer system can also include a network interface through which it receives data from external sources and/or transmits data to external sources. The network interface facilitates the exchange of data with a remote computer system via a link. The link represents a portion of a network, and the remote computer system represents a node of the network.

Modules of the present invention, as well as associated data, can be stored and accessed from any of the computer-readable media associated with the computer system. For example, portions of such modules and portions of associated program data may be included in an operating system, application programs, program modules and/or program data, for storage in a system memory. When a mass storage device, such as a magnetic hard disk, is coupled to the computer system, such modules and associated program data may also be stored in the mass storage device. In a networked environment, program modules and associated data depicted relative to the computer system, or portions thereof, can be stored in remote memory storage devices, such as, for example, system memory and/or mass storage devices associated with a remote computer system. Execution of such modules may be performed in a distributed environment as previously described.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A method of selectively displaying data relating to multiple workflow run instances executed by a software application, the method comprising:
via a graphical user interface, displaying a plurality of workflow run instances arranged in a time-based format;
enabling the selection of at least one workflow run instance via at least one selector block of the graphical user interface; and
depicting data relating to the selected at least one workflow run instance.

2. A method of selectively displaying as defined in claim 1, wherein displaying a plurality of workflow run instances firther comprises displaying a plurality of workflow run instances arranged in a Gantt chart format.

3. A method of selectively displaying as defined in claim 2, wherein each of the plurality of workflow run instances arranged in the Gantt chart format includes at least one workflow run instance portion that is temporally aligned with a timeline of the graphical user interface.

4. A method of selectively displaying as defined in claim 1, wherein displaying a plurality of workflow run instances further comprises displaying a plurality of workflow run instances in a vertically stacked configuration with one another.

5. A method of selectively displaying as defined in claim 1, wherein enabling the selection further comprises enabling the selection of at least one workflow run instance via at least one selector block that is vertically movable along a vertical selector bar, the vertical selector bar being movable in a horizontal direction.

6. A method of selectively displaying as defined in claim 1, wherein each of the workflow run instances is colored differently.

7. A method of selectively displaying as defined in claim 1, wherein enabling the selection further comprises:
enabling the selection of the at least one workflow run instance via at least one selector block of the graphical user interface, wherein the at least one selector block is movable according to user input via at least one of a computer mouse and a computer keyboard.

8. A computer program product for implementing a method of displaying data relating to multiple workflow run instances executed by a software application, the computer program product comprising:
a computer readable medium carrying computer executable instructions for performing the method, the method comprising:
via a graphical user interface, displaying a plurality of workflow run instances arranged in a Gantt chart format;
enabling the selection of at least one workflow run instance via at least one selector of the graphical user interface; and
depicting data relating to the selected at least one workflow run instance.

9. A computer program product as defined in claim 8, wherein displaying a plurality of workflow run instances further comprises displaying a plurality of workflow run instances according to a temporal timeline.

10. A computer program product as defined in claim 8, wherein the amount of data depicted is determined by the size of a selector block of the at least one selector.

11. A computer program product as defined in claim 8, wherein the software application is included with a network analyzer in a communications network environment.

12. A computer program product as defined in claim 8, wherein the data relating to the selected at least one workflow run instance is depicted on a display device together with the graphical user interface.

13. A computer program product as defined in claim 8, wherein the software application includes an output module that includes matching algorithms for configuring the data to be depicted for display on a display device.

14. A computer program product as defined in claim 8, wherein the workflow run instances arranged in the Gantt chart format extend chronologically left to right on a display device.

15. A computer program product as defined in claim 8, wherein enabling the selection further comprises enabling the selection of at least one workflow run instance via two selector blocks.

16. A method of selectively displaying data relating to multiple workflow run instances executed by a software application, the method comprising:
via a graphical user interface, displaying a plurality of workflow run instances arranged in a Gantt chart format;
enabling the selection of at least one workflow run instance via at least two selector blocks of the graphical user interface; and
depicting data relating to the selected at least one workflow run instance.

17. A method of selectively displaying as defined in claim 16, wherein the selector blocks include edge and corner texture portions to enable the size of each selector block to be adjusted.

18. A method of selectively displaying as defined in claim 17, wherein each selector block is configured to be moved via a click and drag operation performed by a user.

19. A method of selectively displaying as defined in claim 18, wherein the at least two selector blocks are positioned on at least one selector bar.

20. A method of selectively displaying as defined in claim 19, wherein the at least one selector bar is at least one vertical selector bar.

21. A method of selectively displaying as defined in claim 20, wherein the at least two selector blocks are moved via user adjustment of the at least one vertical selector bar.

22. A method of selectively displaying as defined in claim 21, wherein the at least two selector blocks are each positioned on different vertical selector bars.

23. A method of selectively displaying as defined in claim 22, wherein the at least one vertical selector bar is subject to a snap to grid aspect of the graphical user interface.
